(19) United States
(12) Patent Application Publication
(10) Pub. No.: US 2004/0041789 A1
(43) Pub. Date: Mar. 4, 2004

(54) Cursor positioning device or method

(76) Inventor: Leo Francis McGanty, San Jacinto, CA (US)

Correspondence Address: Leo Francis McGanty, 393 Palm Avenue, San Jacinto, CA, 92582, US

(21) Appl. No.: 10/229,306

(22) Filed: Aug. 27, 2002

(51) Int. Cl. G09G 5/08

(52) U.S. Cl. 345/163

(57) ABSTRACT

The cursor positioning device is a means by which the cursor on the monitor of a computer can be quickly found and positioned without the annoying procedure of having to move the mouse in all directions, while searching for the cursor. This could be attained by having a separate button on the mouse, or by using the existing buttons already on the mouse. Other means are mentioned in the detailed specifications.

### BACKGROUND OF THE INVENTION

The invention relates to a means or a method, whereby the cursor on a computer monitor is immediately located.

Heretofore, it has been an extreme annoyance and a resulting loss of time, when a computer operator seeks to locate the cursor, often off-screen, by randomly moving the mouse in all directions, until the cursor appears.

It is probably true that with the presently used system it may take only a second or two of additional time to bring the cursor into view to proceed with a program. However, that one second or two, let alone the annoyance, could result in thousands of seconds for a single computer operator in a one-day period.

There is a well-defined need for a device or method by which the cursor could be instantly positioned on the computer, eliminating the annoying search for the cursor.

### SUMMARY OF THE INVENTION

A small button could be added to the mouse to position the cursor to the center of the screen, or to whatever screen position may be desired. In the case of a laptop computer, a corner of the touch pad could act as a button to locate the cursor.

The keyboard could also be used to position the cursor.

The right button on the mouse could be designed so that when a side pressure is exerted on the button, instead of the downward pressure ordinarily used, a signal would be sent to the computer to locate the cursor. A wireless remote command or a focused light beam command could also send these signals.

### BRIEF DESCRIPTION OF THE DRAWINGS

FIG. 1 shows a plan view of a computer mouse 1 with button 2 to signal the computer by pushing the button sideways, in the direction of the arrow 3 to position the cursor.

FIG. 2 shows a plan view of a differently designed computer mouse 4, with a third circular button 5 to position the cursor.

### DESCRIPTION OF THE PREFERRED EMBODIMENTS

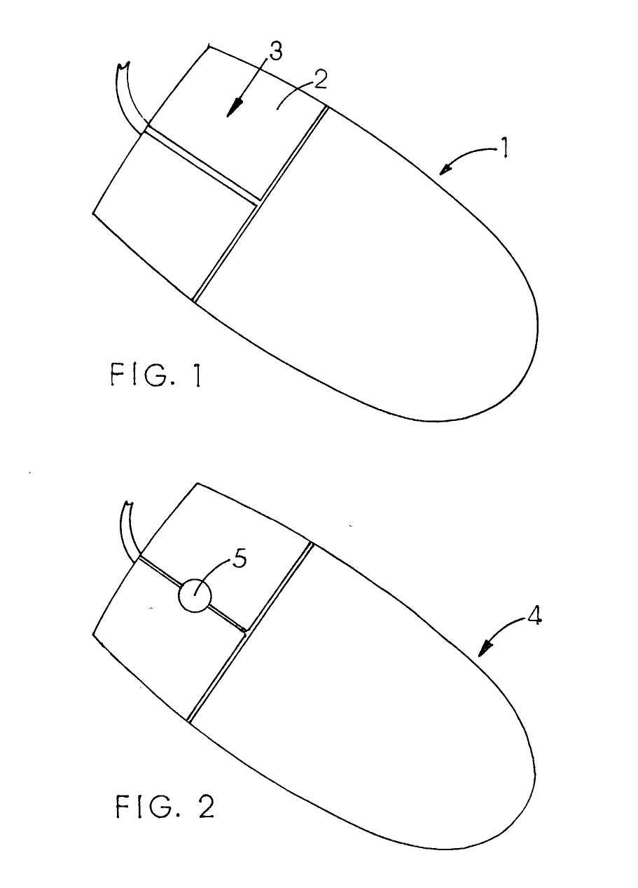

FIG. 1 shows a computer mouse 1 with a uniquely designed button 2 that when pushed on its side, toward the center of the mouse in the direction of the arrow 3, it signals the computer to find and position the cursor on the monitor.

FIG. 2 shows a computer mouse 4 with an added button 5 to position the cursor. Button 5 could, of course, be located anywhere on the mouse. It may also be located on the monitor.

If the computer uses a system such as a remote light beam, radio beam, or a touch pad or touch monitor, such a system could be programmed with a signal that would instantly position the cursor. A combination of any of these systems could also accomplish the task of locating the cursor.

The objective of any and all of the methods above is to instantly position the cursor on the monitor to a desired, pre-programmed location.

That which is claimed is:

1. A cursor positioning device or method, using a mouse button or buttons to instantly bring into view the mouse cursor in a specific, designated location on the monitor, or the use of the keyboard to position the cursor, or the use of a touch pad or touch screen to position the cursor, or the use of a remote wireless radio or light beam to position the cursor; these methods or any combination of these methods, or any other means to position the cursor to whatever monitor position may be desired.

2. A cursor positioning device or method as defined in claim 1 wherein: a computer mouse button while incorporating its usual design to push downward is also designed to push sideways, toward the center of the mouse, such button when pushed sideways would position the cursor at a desired location on the monitor.
